(19) United States
(12) Patent Application Publication
(10) Pub. No.: US 2025/0146642 A1
(43) Pub. Date: May 8, 2025

(54) VEHICLE LIGHTING EQUIPMENT AND VEHICLE LIGHTING EQUIPMENT SYSTEM

(71) Applicant: STANLEY ELECTRIC CO., LTD., Meguro-ku, Tokyo (JP)

(72) Inventors: Taiki MORI, Tokyo (JP); Toshimitsu WATANABE, Kyoto (JP)

(73) Assignee: STANLEY ELECTRIC CO., LTD., Meguro-ku, Tokyo (JP)

(21) Appl. No.: 18/837,768

(22) PCT Filed: Jan. 27, 2023
(86) PCT No.: PCT/JP2023/002667

§ 371 Date: Aug. 12, 2024

(30) Foreign Application Priority Data
Feb. 17, 2022 (JP) 2022-023237

(51) Int. Cl. F21S 41/675; F21S 41/176; F21S 41/25

(52) U.S. Cl. CPC F21S 41/675; F21S 41/176; F21S 41/25

(57) ABSTRACT

A vehicle lighting equipment that irradiates light around a vehicle includes: a first light source, a first scanning mirror, and a first lens disposed on an upper side relative to a second light source, a second scanning mirror, and a second lens, in a vertical direction of the vehicle, and a phosphor plate including a first region on an upper side and a second region on a lower side in the vertical direction, where a first laser light passing through the first scanning mirror and the first lens is irradiated onto the second region of the phosphor plate, and a second laser light passing through the second scanning mirror and the second lens is irradiated onto the first region of the phosphor plate, and where a light generated from the phosphor plate is projected by a projection lens.

### TECHNICAL FIELD

The present disclosure relates to a vehicle lighting equipment and a vehicle lighting equipment system.

### BACKGROUND ART

Japanese Unexamined Patent Application Publication No. 2017-204453 (Patent Document 1) describes a vehicle headlamp having a plurality of excitation light sources, a phosphor, a scanning mechanism that scans the emission light from the excitation light sources toward the phosphor, and a projection lens that transmits the emission light from the phosphor to form a light distribution pattern, in which the irradiation range of light incident on the phosphor differs for each excitation light source.

### PRIOR ART DOCUMENT

### Patent Document

[Patent Document 1] Japanese Unexamined Patent Application Publication No. 2017-204453

### SUMMARY OF THE INVENTION

### Technical Problem

In a specific aspect, it is an object of the present disclosure to facilitate optical design of lenses, etc. in a vehicle lighting equipment or the like.

### Solution to the Problem

(1) A vehicle lighting equipment according to one aspect of the present disclosure is a vehicle lighting equipment that performs light irradiation around a vehicle including: (a) a first light source that emits a first laser light; (b) a first scanning mirror that reflects and scans the first laser light; (c) a first lens that transmits the first laser light scanned by the first scanning mirror; (d) a second light source that emits a second laser light; (e) a second scanning mirror that reflects and scans the second laser light; (f) a second lens that transmits the second laser light scanned by the second scanning mirror; (g) a phosphor plate on which the first laser light transmitted through the first lens and the second laser light transmitted through the second lens are incident; and (h) a projection lens that projects light generated from the phosphor plate; (i) where, in a vertical direction of the vehicle, the first light source, the first scanning mirror, and the first lens are disposed relatively on the upper side of the second light source, the second scanning mirror, and the second lens, (j) where, in the vertical direction of the vehicle, the phosphor plate includes a first region that is relatively on the upper side and a second region that is relatively on the lower side, and (k) where the first laser light passing through the first scanning mirror and the first lens is irradiated onto the second region of the phosphor plate, and the second laser light passing through the second scanning mirror and the second lens is irradiated onto the first region of the phosphor plate. (2) A vehicle lighting equipment system according to one aspect of the present disclosure is a vehicle lighting equipment system including: the vehicle lighting equipment according to the above-described (l); a camera; and controller that controls operation of the vehicle lighting equipment based on an image around the vehicle captured by the camera.

According to the above configurations, it is possible to facilitate optical design of lenses, etc. in a vehicle lighting equipment or the like.

### BRIEF DESCRIPTION OF THE DRAWINGS

FIG. 1 is a diagram showing a configuration of a headlamp according to one embodiment.

FIG. 2 is a schematic front view of a phosphor plate.

FIG. 3 is a diagram for describing a light distribution pattern formed in front of a vehicle by the light emitted by the headlamp.

FIG. 4 is a diagram for describing the distance (optical path length) of the optical path from each scanning mirror to the phosphor plate.

FIG. 5A is a diagram schematically showing the distance of the optical path according to the present embodiment.

FIG. 5B is a diagram schematically showing the distance of the optical path according to a comparative example.

FIG. 6A and FIG. 6B are diagrams schematically showing the configuration of a headlamp according to another embodiment.

FIG. 7 is a block diagram showing a configuration example of a vehicle lighting equipment system configured to include a headlamp.

### MODE FOR CARRYING OUT THE INVENTION

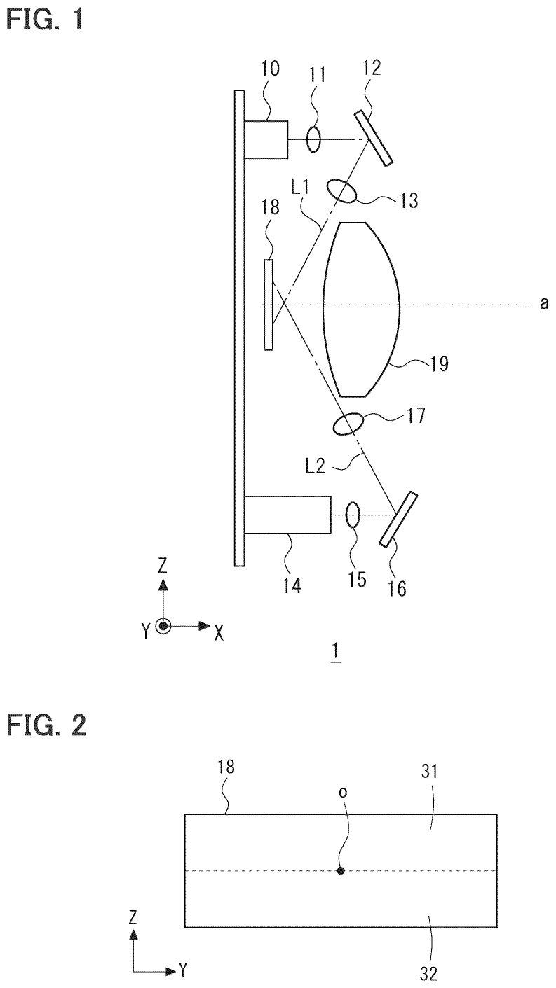

FIG. 1 is a diagram showing a configuration of a headlamp according to one embodiment. This FIG. 1 shows a schematic configuration of a headlamp 1 as viewed from the side. The headlamp 1 shown is mounted on a vehicle and is intended to irradiate light forward of the vehicle. The headlamp 1 is configured to include a first light source 10, a first focusing lens 11, a first scanning mirror 12, a first brightness correction lens 13, a second light source 14, a second focusing lens 15, a second scanning mirror 16, a second brightness correction lens 17, a phosphor plate 18, and a projection lens 19. The X direction in the figure corresponds to the front-rear direction of the headlamp 1, the Y direction corresponds to the left-right direction of the headlamp 1, and the 2 direction corresponds to the up-down direction of the headlamp 1. When the headlamp 1 is mounted on the vehicle, the X direction in the figure corresponds to the front-rear direction of the vehicle, the Y direction corresponds to the left-right direction of the vehicle, and the Z direction corresponds to the up-down direction of the vehicle.

The first light source 10 is a light source that emits laser light. The laser light emitted from the first light source 10 is visible light such as blue light. This first light source 10 may be equipped with a collimating lens that focuses the laser light. The first light source 10 is disposed on the upper part side of the headlamp 1 (the upper side in the Z direction in the figure) relative to the second light source 14. Here, “the upper part side of the headlamp 1” is synonymous with “the relatively upper side in the vertical direction of the vehicle on which the headlamp 1 is mounted”, and “the lower part side of the headlamp 1” is synonymous with “the relatively lower side in the vertical direction of the vehicle on which the headlamp 1 is mounted” (the same applies hereinafter).

The first focusing lens 11 is disposed in the direction of travel of the laser light emitted from the first light source 10, and focuses the laser light to make it incident on the first scanning mirror 12. The first focusing lens 11 is disposed on the upper part side of the headlamp 1 relative to the second focusing lens 15.

The first scanning mirror 12 is disposed at a position where the laser light emitted from the first light source 10 and focused by the first focusing lens 11 is incident, and reflects and scans the laser light, causing it to be incident onto the phosphor plate 18. As the first scanning mirror 12, for example, a MEMS (Micro Electro Mechanical Systems) mirror capable of scanning the incident light in two orthogonal directions is preferably used, but is not limited thereto. The first scanning mirror 12 is disposed on the upper part side of the headlamp 1 relative to the second scanning mirror 16.

The first brightness correction lens 13 is disposed at a position where the laser light scanned by the first scanning mirror 12 can enter, and improves the brightness of the laser light at the phosphor plate 18 by expanding the scanning width of the laser light. The first brightness correction lens 13 is disposed on the upper part side of the headlamp 1 relative to the second brightness correction lens 17. Further, the first brightness correction lens 13 is disposed on the lower part side of the headlamp 1 relative to the first light source 10, the first focusing lens 11, and the first scanning mirror 12, and on the upper part side of the headlamp 1 relative to the projection lens 19.

The second light source 14 is a light source that emits laser light. The laser light emitted from the second light source 14 is visible light such as blue light. This second light source 14 may be equipped with a collimating lens that focuses the laser light. The second light source 14 is disposed on the lower part side of the headlamp 1 (the lower side in the 2 direction in the figure) relative to the first light source 10.

The second focusing lens 15 is disposed in the direction of travel of the laser light emitted from the second light source 14, and focuses the laser light to make it incident on the second scanning mirror 16. The second focusing lens 15 is disposed on the lower part side of the headlamp 1 relative to the first focusing lens 11.

The second scanning mirror 16 is disposed at a position where the laser light emitted from the second light source 14 and focused by the second focusing lens 15 is incident, and reflects and scans the laser light, causing it to be incident onto the phosphor plate 18. As the second scanning mirror 16, for example, a MEMS (Micro Electro Mechanical. Systems) mirror capable of scanning the incident light in two orthogonal directions is preferably used, but is not limited thereto. The second scanning mirror 16 is disposed on the lower part side of the headlamp 1 relative to the first scanning mirror 12.

The second brightness correction lens 17 is disposed at a position where the laser light scanned by the second scanning mirror 16 can be incident, and improves the brightness of the laser light at the phosphor plate 18 by expanding the scanning width of the laser light. The second brightness correction lens 17 is disposed on the lower part side of the headlamp 1 relative to the first brightness correction lens 13. Further, the second brightness correction lens 17 is disposed on the upper part side of the headlamp 1 relative to the second light source 14, the second focusing lens 15, and the second scanning mirror 16, and on the lower part side of the headlamp 1 relative to the projection lens 19.

The phosphor plate 18 is a plate-shaped body including phosphor, and is disposed between the first light source 10 and the second light source 14 in the vertical direction of the headlamp 1, and is disposed at a position where a first laser light L1 passing from the first light source 10 through the first focusing lens 11, the first scanning mirror 12 and the first brightness correction lens 13, and a second laser light 12 passing from the second light source 14 through the second focusing lens 15, the second scanning mirror 16 and the second brightness correction lens 17 are incident. This phosphor plate 18 is configured to include, for example, a yellow phosphor, and when the first laser light L1 and the second laser light 12, each of which has a blue wavelength, are incident on the phosphor plate, the first laser light L1, and the second laser light 12 are reflected and yellow light is generated by the yellow phosphor. As a result, white light (pseudo white light) is emitted from the phosphor plate 18. The projection lens 19 is disposed in front of the phosphor plate 18 so that its optical axis “a” corresponds approximately to the center of the phosphor plate 18, and collects the light emitted from the phosphor plate 18 and projects it forward of the vehicle.

FIG. 2 is a schematic front view of the phosphor plate. The phosphor plate 18 has a first region 31 on the upper side and a second region 32 on the lower side along the 2 direction, sandwiching a central position “o” in the Y direction and z direction in the figure. In the present embodiment, the phosphor plate 18 is disposed so that the optical axis “a” of the projection lens 19 described above is approximately perpendicular to the phosphor plate 18 at the central position “o”.

Within the first region 31 of the phosphor plate 18, the second laser light L2 is irradiated from the second light source 14 through the second focusing lens 15, the second scanning mirror 16, and the second brightness correction lens 17. Further, within the second region 32 of the phosphor plate 18, the first laser light L1 is irradiated from the first light source 10 through the first focusing lens 11, the first scanning mirror 12, and the first brightness correction lens 13. Therefore, as shown in FIG. 1, the first laser light L1 and the second laser light L2 cross each other in front of the phosphor plate 18 when they are irradiated onto the phosphor plate 18.

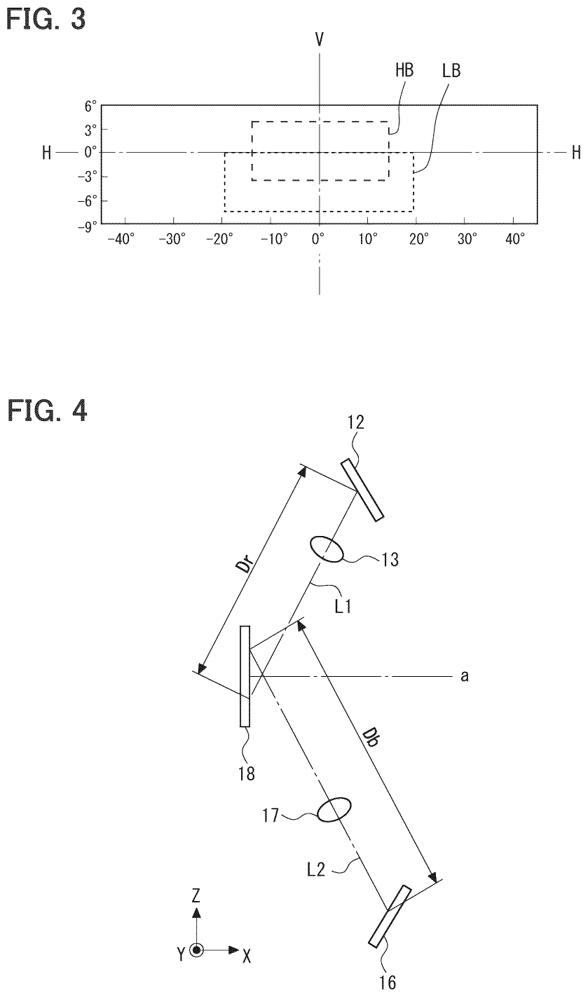

FIG. 3 is a diagram for describing a light distribution pattern formed in front of a vehicle by the light emitted by the headlamp. Here, for example, a light distribution pattern formed on a virtual screen assumed to be located 25 meters ahead of the vehicle will be described. Here, note that this light distribution pattern may be formed using one headlamp 1, or may be formed by combining the light emitted by two headlamps 1.

As shown in the figure, the light distribution pattern has a high beam HB and a low beam LB. The high beam HB is irradiated within the range of approximately +3.8° to approximately −3.6° in V direction (the vertical direction) in the figure, and within the range of approximately #14.4° in H direction in the figure. This high beam HB is formed by the first laser light L1 that is irradiated to the second region 32 of the phosphor plate 18. For example, when it is desired to selectively irradiate light depending on the situation such as another vehicle in front, such a light distribution pattern can be realized by switching on and off during scanning of the first laser light L1.

The low beam LB is irradiated within the range of 0° to approximately −7.5° in the V direction in the figure, and within the range of approximately ±19.4° in the H direction in the figure. Comparing these irradiation ranges in the H direction, the low beam LB is wider than the high beam HB. Further, comparing these irradiation ranges in the V direction, the low beam LB and high beam HB are almost the same. This low beam LB is formed by the second laser light 12 that is irradiated to a first region 31 of the phosphor plate 18. As shown in the figure, the low beam LB is partially overlapped by the high beam HB. Such a light distribution pattern is realized by the lens design of the projection lens 19.

FIG. 4 is a diagram for describing the distance (optical path length) of the optical path from each scanning mirror to the phosphor plate. As shown in the figure, in the headlamp 1 of the present embodiment, the optical path distance Db from the second scanning mirror 16 to the phosphor plate 18 via the second brightness correction lens 17 is longer than the optical path distance Dr from the first scanning mirror 12 to the phosphor plate 18 via the first brightness correction lens 13 (Dr<Db). Since this is due to the requirement of the exterior design of the lamp unit 1, it is necessary to reduce the volume of the upper side of the lamp unit 1, which is the part exposed to the outside of the vehicle, while there is little need to do so for the lower side of the lamp unit 1 which can be partially housed inside the vehicle.

In other words, the optical path distance Dr from the first scanning mirror 12 to the phosphor plate 18 via the first brightness correction lens 13, which is disposed relatively on the upper side of the lamp unit 1 needs to be shorter, while it is easier to maintain a longer distance for the optical path distance Db from the second scanning mirror 16 to the phosphor plate 18 via the second brightness correction lens 17.

Further, in the present embodiment, by using the second laser light L2, which can set the optical path distance longer and therefore can provide a wider light distribution angle, a low beam LB with a relatively wide light distribution range is formed (refer to FIG. 3), and by using the first laser light L1, which has a relatively short optical path distance, a high beam HB with a relatively narrow light distribution range is formed. Thereby, since this loosens the requirement for the optical characteristics (e.g. lens curvature) required for each of the first brightness correction lens 13 and the second brightness correction lens 17, the effect of facilitating the optical design and manufacture of each lens can be achieved.

Further, in the present embodiment, by causing the first laser light L1 and the second laser light 12 to intersect in front of the phosphor plate 18, the first laser light L1 traveling from the relatively upper side to the lower side of the headlamp 1 is irradiated onto the second region 32, which is the relatively lower side of the phosphor plate 18, and the second laser light 12 traveling from the relatively lower side to the upper side of the headlamp 1 is irradiated onto the first region 31, which is the relatively upper side of the phosphor plate 18. Thereby, for example, in comparison with a case where the first laser light L1 is irradiated to the first region 31 of the phosphor plate 18 and the second laser light 12 is irradiated to the second region 32 of the phosphor plate 18, the optical path distances Dr and Rb can be made longer. As a result, the distance between the first scanning mirror 12 and the first brightness correction lens 13 can be made longer, and the distance between the second scanning mirror 16 and the second brightness correction lens 17 can be made longer, so that the region through which each laser light passes through the optical surface in order to obtain brightness improvement effect due to each lens becomes wider, and brightness correction effect can be improved.

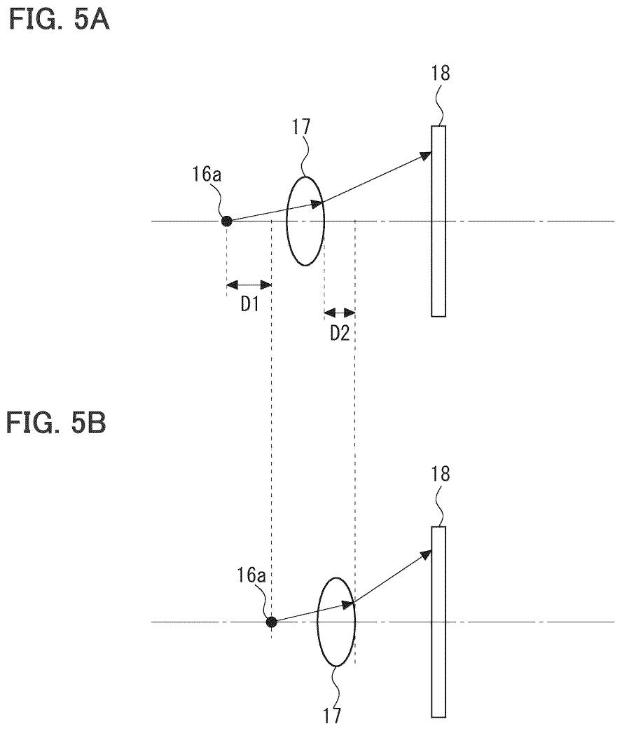

FIG. 5A is a diagram schematically showing the distance of the optical path according to the present embodiment. FIG. 5B is a diagram schematically showing the distance of the optical path according to a comparative example. Here, the optical path from the rotation starting point 16a of the second scanning mirror 16 to the phosphor plate 18 via the second brightness correction lens 17 is schematically shown. Note that the same holds true for the optical path from the rotation starting point of the first scanning mirror 13 to the phosphor plate 18 via the first brightness correction lens 13. As shown in FIG. 5A, in the headlamp 1 of the present embodiment, the distance between the second scanning mirror 16 and the second brightness correction lens 17 can be increased. The increased distance compared to the comparative example shown in FIG. 5B is indicated as D1 in the figure. Furthermore, as shown in FIG. 5A, in the headlamp 1 of the present embodiment, the distance between the second brightness correction lens 17 and the phosphor plate 18 can also be increased. The increased distance compared to the comparative example shown in FIG. 5B is indicated as D2 in the figure. By increasing these distances D1 and D2, the above-described effect is achieved, and as a result, the effect of facilitating the optical design and manufacture of each lens is achieved.

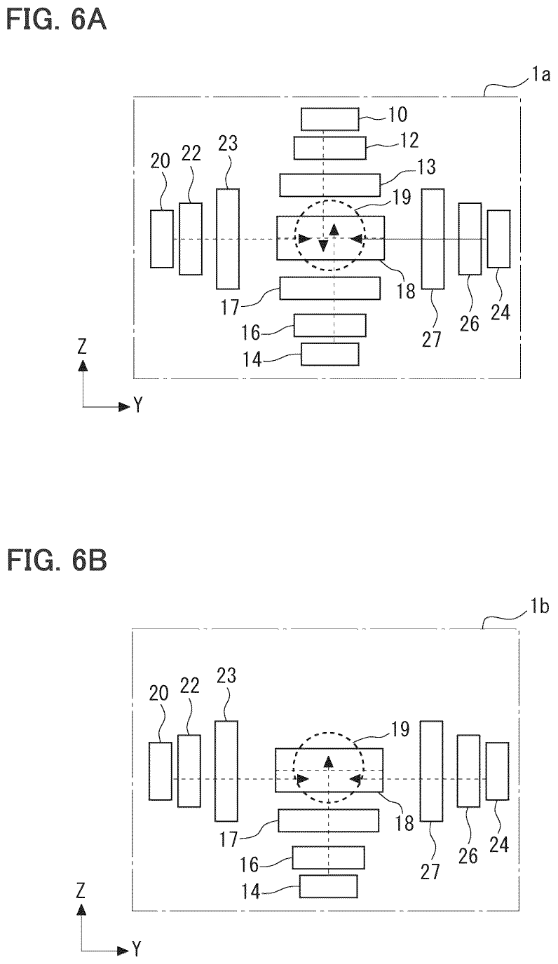

FIG. 6A is a diagram schematically showing the configuration of a headlamp according to another embodiment. The headlamp 1a of the embodiment shown in FIG. 6A is similar to the above-described embodiment in that the first light source 10, the first scanning mirror 12, the first brightness correction lens 13, etc. are disposed relatively on the upper side in the Z direction, and the second light source 14, the second scanning mirror 16, the second brightness correction lens 17, etc. are disposed relatively on the lower side. Further, a third light source 20, a third scanning mirror 22, and a third brightness correction lens 23, which are similarly configured, are disposed on the left side in the Y direction in the figure, and a fourth light source 24, a fourth scanning mirror 26, and a fourth brightness correction lens 27 are disposed on the right side in the Y direction in the figure. Here, the focusing lenses are omitted from the figure.

In this headlamp 1a, a laser light passing through the first brightness correction lens 13 and a laser light passing through the second brightness correction lens 17 are irradiated onto the phosphor plate 18 from the above and below directions, and further, a laser light light passing through the third brightness correction lens 23 and a laser light passing through the fourth brightness correction lens are irradiated onto the phosphor plate 18 from the left and right directions. Therefore, this allows light distribution pattern irradiated in front of the vehicle through the projection lens 19 to be changed in a more versatile way.

Here, a part of the configuration of the headlamp 1a of the embodiment shown in FIG. 6A may be omitted. As an example, FIG. 6B shows a configuration of a headlamp 1b of an embodiment in which the first light source 10, the first scanning mirror 12, the and first brightness correction lens 13 are omitted.

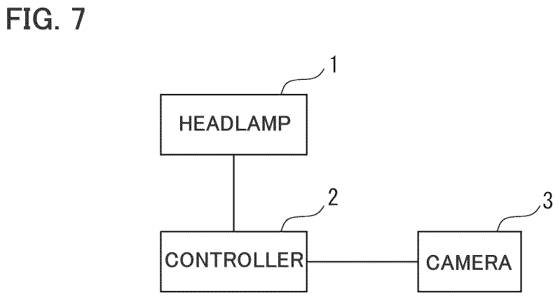

FIG. 7 is a block diagram showing a configuration example of a vehicle lighting equipment system configured to include a headlamp. The vehicle lighting equipment system shown in the figure is configured to include a headlamp 1, a controller 2, and a camera 3. Here, the headlamp 1 can be substituted for the headlamp 1a or 1b described above. This vehicle lighting equipment system detects objects such as a preceding vehicle, an oncoming vehicle, and a pedestrian by performing information processing in the controller 2 using an image around the vehicle (for example, the front) captured by the camera 3, dynamically sets a light irradiation region and a dimming region (or a non-irradiation region) mainly within the irradiation range of a high beam HB according to their positions and the situation, and controls operation of the headlamp 1 by the controller 2 so as to realize a light distribution pattern including the light irradiation region and the dimming region. Specifically, the vehicle lighting system controls the timing of turning on and off the first light source 10 and second light source 14 of the headlamp 1, and by having the operation of the first scanning mirror 12 and the second scanning mirror 16 controlled by the controller 2, a desired light distribution pattern is realized. The controller 2 can be realized using a computer system that includes, for example, a CPU, ROM, RAM or the like and can execute a predetermined operating program.

According to each of the above-described embodiments, it is possible to facilitate optical design of lenses, etc. in a headlamp (a vehicle lighting equipment) or the like. Here, the present disclosure is not limited to the content of each of the embodiments described above, and can be implemented with various modifications within the scope of the gist of the present disclosure. For example, in the above-described embodiments, a headlamp is shown as an example of a vehicle lighting equipment, but a similar configuration can be applied to a lamp that irradiates light in any direction, such as toward the rear or sides of a vehicle.

### REFERENCE SIGNS LIST

1: Headlamp
10: First light source
11: First focusing lens
12: First scanning mirror
13: First brightness correction lens
14: Second light source
15: Second focusing lens
16: Second scanning mirror
17: Second brightness correction lens
18: Phosphor plate
19: Projection lens
L1: First laser light
L2: Second laser light

1. A vehicle lighting equipment that performs light irradiation around a vehicle comprising:
a first light source that emits a first laser light;
a first scanning mirror that reflects and scans the first laser light;
a first lens that transmits the first laser light scanned by the first scanning mirror;
a second light source that emits a second laser light;
a second scanning mirror that reflects and scans the second laser light;
a second lens that transmits the second laser light scanned by the second scanning mirror;
a phosphor plate on which the first laser light transmitted through the first lens and the second laser light transmitted through the second lens are incident; and
a projection lens that projects a light generated from the phosphor plate;
wherein, in a vertical direction of the vehicle, the first light source, the first scanning mirror, and the first lens are disposed relatively on an upper side of the second light source, the second scanning mirror, and the second lens,
wherein, in the vertical direction of the vehicle, the phosphor plate includes a first region that is relatively on an upper side and a second region that is relatively on a lower side,
wherein the first laser light passing through the first scanning mirror and the first lens is irradiated onto the second region of the phosphor plate, and the second laser light passing through the second scanning mirror and the second lens is irradiated onto the first region of the phosphor plate, and
wherein a distance of a second optical path from the second scanning mirror to the phosphor plate via the second lens is longer than a distance of a first optical path from the first scanning mirror to the phosphor plate via the first lens.

2. (canceled)

3. The vehicle lighting equipment according to claim 1, wherein light generated from the first region of the phosphor plate is projected by the projection lens to a relatively lower side in the vertical direction of the vehicle, and light generated from the second region of the phosphor plate is projected by the projection lens to a relatively upper side in the vertical direction of the vehicle.

4. The vehicle lighting equipment according to claim 1, wherein each of the first lens and the second lens is a brightness correction lens.

5. (canceled)

6. The vehicle lighting equipment according to claim 1, wherein, in the vertical direction of the vehicle, the first lens is disposed relatively on a lower side of the first light source and the first scanning mirror, and
wherein, in the vertical direction of the vehicle, the second lens is disposed relatively on an upper side of the second light source and the second scanning mirror.

7. The vehicle lighting equipment according to claim 1 further comprising:
a first focusing lens disposed between the first light source and the first scanning mirror; and
a second focusing lens disposed between the second light source and the second scanning mirror.

8. A vehicle lighting equipment system comprising: the vehicle lighting equipment according to claim 1;
a camera; and
a controller that controls operation of the vehicle lighting equipment based on an image around the vehicle captured by the camera.

9. A vehicle lighting equipment that performs light irradiation around a vehicle comprising:
a first light source that emits a first laser light;
a first scanning mirror that reflects and scans the first laser light;
a first lens that transmits the first laser light scanned by the first scanning mirror;
a second light source that emits a second laser light;
a second scanning mirror that reflects and scans the second laser light;
a second lens that transmits the second laser light scanned by the second scanning mirror;
a phosphor plate on which the first laser light transmitted through the first lens and the second laser light transmitted through the second lens are incident; and
a projection lens that projects a light generated from the phosphor plate;
wherein, in a vertical direction of the vehicle, the first light source, the first scanning mirror, and the first lens are disposed relatively on an upper side of the second light source, the second scanning mirror, and the second lens,
wherein, in the vertical direction of the vehicle, the phosphor plate includes a first region that is relatively on an upper side and a second region that is relatively on a lower side,
wherein the first laser light passing through the first scanning mirror and the first lens is irradiated onto the second region of the phosphor plate, and the second laser light passing through the second scanning mirror and the second lens is irradiated onto the first region of the phosphor plate, and
wherein the first laser light passing through the first scanning mirror and the first lens and the second laser light passing through the second scanning mirror and the second lens intersect on a front side of the phosphor plate.
